(19) United States
(12) Patent Application Publication
(10) Pub. No.: US 2016/0326654 A1
(43) Pub. Date: Nov. 10, 2016

(54) SURFACE-TREATED SUBSTRATE AND SUBSTRATE SURFACE TREATMENT METHOD FOR SAME

(71) Applicant: POSCO, Pohang-si (KR)

(72) Inventors: Hyunju JEONG, Hwaseong-si (KR); Kyoung-Bo KIM, Incheon (KR); Ha Sun PARK, Incheon (KR); Moo Jin KIM, Incheon (KR); Kyoung Sik KIM, Incheon (KR); Hyoun-Young LEE, Incheon (KR)

(21) Appl. No.: 15/108,429

(22) PCT Filed: Dec. 26, 2014
(86) PCT No.: PCT/KR2014/012917

§ 371 Date: Jun. 27, 2016

(30) Foreign Application Priority Data
Dec. 26, 2013 (KR) 10-2013-0164044
Dec. 26, 2013 (KR) 10-2013-0164045
Dec. 26, 2013 (KR) 10-2013-0164046
Dec. 26, 2013 (KR) 10-2013-0164047
Dec. 26, 2014 (KR) 10-2014-0190347
Dec. 26, 2014 (KR) 10-2014-0190373

(51) Int. Cl. C23C 22/64; C09D 5/08; C23C 22/73

(52) U.S. Cl. CPC C23C 22/64; C23C 22/73; C09D 5/08

(57) ABSTRACT

The present invention relates to a surface-treated substrate having excellent corrosion resistance and capable of developing color on the surface, and to a substrate surface treatment method for same. The surface-treated substrate, according to the present invention, comprises a coating having a uniform thickness on a metal matrix, thereby improving corrosion resistance and evenly developing color on the surface. Also, by comprising a wavelength conversion layer and a top coat, in order, on top of the coating, the advantage of improving scratch resistance and durability of the substrate without discoloring of the achieved color can be provided.

### TECHNICAL FIELD

The present invention relates to a surface-treated substrate having excellent corrosion resistance and for developing a color on a surface thereof, and a substrate surface treatment method therefor.

### BACKGROUND ART

Magnesium is a metal which belongs to lightweight metals among practical metals, has excellent wear resistance, and is very resistant to sunlight and eco-friendly, but has a difficulty in realizing a metal texture and various colors. Further, since it is a metal having the lowest electrochemical performance and is highly active, when a color treatment is not performed thereon, it may be quickly corroded in air or in a solution, and thus has a difficulty in industrial application.

Recently, the magnesium industry has been receiving attention due to the weight reduction trend in overall industry. As exterior materials with a metal texture has become trendy in the field of electrical and electronic component materials such as mobile phone case components, research to resolve the above-described problem of magnesium is being actively carried out.

As a result, Korean Patent Laid-open Publication No. 2011-0016750 disclosed a PVD-sol gel method of performing sol-gel coating after dry coating a surface of a substrate formed of a magnesium alloy with a metal-containing material in order to realize a metal texture and ensure corrosion resistance, and Korean Patent Laid-open Publication No. 2011-0134769 disclosed an anodic oxidation method of imparting gloss to a surface of a substrate including magnesium using chemical polishing and coloring a surface by anodic oxidation of the substrate in an alkaline electrolyte including a pigment dissolved therein.

However, the PVD-sol gel method has a problem in that a texture realized on the surface of the substrate is not the intrinsic texture of magnesium although a metal texture may be realized on the surface of the substrate, and the realization of a variety of colors is difficult. Furthermore, when a color treatment is performed using the anodic oxidation method, there is a problem in that an opaque oxide film is formed on the surface of the substrate, and the realization of the intrinsic texture of metals is not easy.

Accordingly, there is an urgent need for a technique to improve corrosion resistance by chemically, electrochemically or physically treating the surface of the substrate and to realize a desired color on the surface for commercialization of a substrate including magnesium.

### DISCLOSURE

### Technical Problem

An objective of the present invention is to provide a surface-treated substrate having excellent corrosion resistance and for developing a color on a surface thereof.

Another objective of the present invention is to provide a substrate surface treatment method therefor.

### Technical Solution

In order to achieve the objectives, an embodiment of the present invention provides a color-treated substrate, including:

a metal matrix;

a film formed on the matrix and containing a compound represented by the following Chemical Formula 1;

a wavelength conversion layer formed on the film; and

a top coat formed on the wavelength conversion layer:

M(OH)m [Chemical Formula 1]

where M includes one or more selected from the group consisting of Na, K, Mg, Ca and Ba, and m is 1 or 2.

Further, another embodiment of the present invention provides a method of surface-treating a substrate, including:

a step of forming a film on a metal matrix;

a step of forming a wavelength conversion layer on the film; and

a step of forming a top coat on the wavelength conversion layer.

### Advantageous Effects

The surface-treated substrate according to the present invention not only can improve corrosion resistance, but also can uniformly develop a color on a surface by including a film having a uniform thickness on a metal matrix. Further, scratch resistance and durability of the substrate can be improved without a change in a color developed on the film by sequentially including a wavelength conversion layer and a top coat on the film.

### DESCRIPTION OF DRAWINGS

FIG. 1 shows images illustrating a thickness of a film according to immersion time, which is measured using a transmission electron microscope in an embodiment: where A shows a substrate in accordance with the immersion time of 10 minutes; B shows a substrate in accordance with the immersion time of 170 minutes; and C shows a substrate in accordance with the immersion time of 240 minutes.

FIG. 2 is an image showing a surface-treated substrate including a chromium (Cr) layer, which is taken by a transmission electron microscope in an embodiment: where D1 is a thickness of a chromium layer, and the value thereof is about 10 nm

FIG. 3 is an image showing a surface-treated substrate including an aluminum (Al) layer, which is taken by a transmission electron microscope in an embodiment: where D2 is a thickness of an aluminum layer, and the value thereof is about 13 nm

### BEST MODE FOR CARRYING OUT THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Further, in the drawings of the present invention, the size and relative sizes of layers, regions and/or other elements may be exaggerated or reduced for clarity.

The embodiments of the present invention will be described with reference to the drawings. Throughout the specification, like reference numerals designate like elements and a repetitive description thereof will be omitted.

“Color coordinates”, as used herein, refer to coordinates in a CIE color space, including color values defined by the Commission International de l'Eclairage (CIE), and any position in the CIE color space may be expressed as three coordinate values of L*, a* and b*.

Here, an L* value represents brightness. L*=0 represents a black color, and L*=100 represents a white color. Moreover, an a* value represents whether a color at a corresponding color coordinate leans toward a pure magenta color or a pure green color, and a b* value represents whether a color at a corresponding color coordinate leans toward a pure yellow color or a pure blue color.

Specifically, the a* value ranges from −a to +a, the maximum a* value (a* max) represents a pure magenta color, and the minimum a* value (a*min) represents a pure green color. For example, when an a* value is negative, a color leans toward a pure green color, and when an a* value is positive, a color leans toward a pure magenta color. This indicates that, when a*=80 is compared with a*=50, a*=80 represents a color which is closer to a pure magenta color than a*=50. Furthermore, the b* value ranges from −b to +b. The maximum b* value (b*max) represents a pure yellow color, and the minimum b* value (b*min) represents a pure blue color. For example, when a b* value is negative, a color leans toward a pure blue color, and when a b* value is positive, a color leans toward a pure yellow color. This indicates that, when b*=50 is compared with b*=20, b*=80 shows a color which is closer to a pure yellow color than b*=50.

Further, a “color deviation” or a “color coordinate deviation”, as used herein, refers to a distance between two colors in the CIE color space. That is, a longer distance denotes a larger difference in color, and a shorter distance denotes a smaller difference in color, and this may be expressed by ΔE* represented by the following Expression 3:

ΔE*=\sqrt{(ΔL*)²+(Δα*)²+(Δb*)²} [Expression 3]

Furthermore, a “wavelength conversion layer”, as used herein, refers to a layer for controlling a wavelength of incident light by adjusting reflection, refraction, scattering, diffraction or the like of light, which may serve to minimize additional refraction and scattering, in a top coat, of light refracted and scattered in a film, and maintain a color developed by the layer by inducing light reflection.

Lastly, a unit “T”, as used herein, represents a thickness of a substrate including magnesium, and is the same as a unit “mm”.

The present invention provides a surface-treated substrate and a substrate surface treatment method therefor.

A PVD-sol gel method, an anodic oxidation method or the like, which is a method of coating a surface of a material with a metal-containing material, a pigment or the like, has been conventionally known as a method for realizing a color on the material including magnesium. However, these methods may cause a reduction in durability of the substrate. Further, it is difficult to realize various colors on the surface of the material, and there is a problem of unmet reliability because a coated film layer is easily detached.

In order to address these issues, the present invention suggests a surface-treated substrate prepared by sequentially stacking a wavelength conversion layer and a top coat after immersing a metal matrix in a hydroxide solution. The substrate according to the present invention has an advantage in that a uniform color is developed on a substrate surface and scratch resistance and durability of the substrate may be improved by sequentially including a film, a wavelength conversion layer and a top coat on a metal matrix.

Hereinafter, the present invention will be described in further detail.

An embodiment of the present invention provides a surface-treated substrate, including:

a metal matrix;

a film formed on the matrix and containing a compound represented by the following Chemical Formula 1;

a wavelength conversion layer formed on the film; and

a top coat formed on the wavelength conversion layer:

M(OH)m [Chemical Formula 1]

where M includes one or more selected from the group consisting of Na, K, Mg, Ca and Ba, and m is 1 or 2.

The surface-treated substrate according to the present invention may include a film on a metal matrix and have a structure in which a wavelength conversion layer and a top coat are sequentially stacked on the film. This stacked structure may be formed on one or both surfaces of the metal matrix. Here, the film is formed on the metal matrix and serves to develop a color, and the top coat, which is the outermost layer, functions to improve scratch resistance and durability of the substrate, but when only the film and top coat are formed on the metal matrix, there is a problem in that a color developed by the film is changed due to the top coat. However, the surface-treated substrate according to the present invention may prevent discoloration due to the top coat by forming a wavelength conversion layer between the film and the top coat.

Here, the type or form of the wavelength conversion layer is not particularly limited as long as the wavelength conversion layer may minimize additional refraction and scattering, in the top coat, of light, refracted and/or scattered in the film, and maintain a color developed by the film by inducing light reflection. Specifically, the wavelength conversion layer may include one or more selected from the group consisting of metals including aluminum (Al), chromium (Cr), titanium (Ti), gold (Au), molybdenum (Mo), silver (Ag), manganese (Mn), zirconium (Zr), palladium (Pd), platinum (Pt), cobalt (Co), cadmium (Cd) or copper (Cu) and ions thereof, and specifically, may include chromium (Cr). Further, the metals may be in the form of metal particles, and may include various types such as a metal nitride, a metal oxide, a metal carbide or the like by reacting with a nitrogen gas, an ethane gas, an oxygen gas and the like in the process of forming the wavelength conversion layer. Moreover, the wavelength conversion layer may be a continuous layer in which the metals are densely stacked on the film and fully cover the surface of the film, or a discontinuous layer in which the metals are dispersed on the film.

Further, an average thickness of the wavelength conversion layer is not particularly limited as long as a change in color developed by the film may be prevented. Specifically, the average thickness may satisfy a condition in the range of 5 to 200 nm More specifically, the average thickness may be in the range of 5 to 150 nm, 10 to 100 nm, 5 to 20 nm, 10 to 15 nm, 20 to 40 nm, 10 to 30 nm, or 30 to 50 nm.

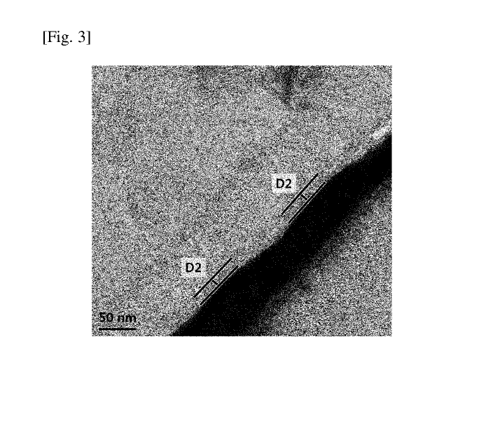

Referring to FIGS. 2 and 3, the substrate has a structure in which a film, a wavelength conversion layer and a top coat are sequentially stacked on a metal matrix. Further, as a result of transmission electron microscope imaging of the surface-treated substrate according to the present invention which contains chromium (Cr) or aluminum (Al), it can be determined that the average thickness of each wavelength conversion layer is about 10 nm and 13 nm, respectively.

Moreover, in the surface-treated substrate according to the present invention,

at any three points included in an arbitrary region with a width of 1 cm and a length of 1 cm which is present on the top coat, an average color coordinate deviation (ΔL*, Δa*, Δb*) of each point may satisfy one or more conditions of ΔL*<0.5, Δa*<0.7 and Δb*<0.6.

Specifically, the surface-treated substrate according to the present invention may satisfy two or more of the conditions, and more specifically, may satisfy all the conditions.

In an embodiment, a sample with a size of 1 cm×1 cm as a metal matrix was immersed in a 10 wt % NaOH solution at 100° C. for 85 minutes, a wavelength conversion layer and a top coat were sequentially formed thereon, and then the color coordinates in a CIE color space of any three points which are present on the sample were measured. The results of color coordinate deviations were respectively 0.14≦ΔL*<0.34, 0.02≦Δa*<0.34 and 0.34≦Δb*<0.40, all of which satisfy the conditions. Further, the ΔE* derived from the measured values was determined as 0.424≦ΔE*<0.578, which indicates a significantly small value of color coordinate deviation. This shows that the surface-treated substrate according to the present invention has a uniform color (refer to Experimental Example 3).

Further, the film of the surface-treated substrate is not particularly limited as long as the film may scatter and refract the light incident to the surface. Specifically, the film may include one or more of sodium hydroxide (NaOH), potassium hydroxide (KOH), magnesium hydroxide (Mg(OH)₂), calcium hydroxide (Ca(OH)₂) and barium hydroxide (Ba(OH)₂), and more specifically, may include magnesium hydroxide (Mg(OH)₂) (refer to Experimental Example 2).

Further, an average thickness of the film may be specifically in the range of 50 nm to 2 μm, and more specifically, in the range of 100 nm to 1 μm, but is not particularly limited thereto. A color is realized on the surface-treated substrate according to the present invention using the nature of light incident to a substrate surface, and a uniform color may be realized by uniformly forming the film for scattering and refracting light incident to the substrate surface. Here, in the present invention, a desired color may be realized without loss of the intrinsic texture of metals of the substrate within the above-described range.

Moreover, the type or form of a metal matrix of the surface-treated substrate is not particularly limited. As a specific example, a magnesium substrate formed of magnesium; a stainless steel or titanium (Ti) substrate of which a surface has magnesium dispersed therein or the like may be used.

Further, a clear coating agent for forming a top coat of the surface-treated substrate is not particularly limited as long as it is a clear coating agent which is applicable to coatings of metals, metal oxides or metal hydroxides. More specifically, a matte clear coating agent or a glossy/matte clear coating agent which is applicable to metal coatings or the like may be exemplified as the clear coating agent.

Another embodiment of the present invention provides a method of surface-treating a substrate, including:

a step of forming a film on a metal matrix;

a step of forming a wavelength conversion layer on the film; and

a step of forming a top coat on the wavelength conversion layer.

Hereinafter, each step of the surface treatment method according to the present invention will be described in further detail.

First, the step of forming the film on the metal matrix is a step for realizing a color on a metal matrix. The color is realized by the film formed on the metal matrix, and the film may be uniformly formed by immersing the metal matrix in the hydroxide solution.

Here, any solution including a hydroxyl group (—OH group) may be used as the hydroxide solution, without particular limitation. Specifically, a solution having one or more selected from the group consisting of NaOH, KOH, Mg(OH)₂, Ca(OH)₂ and Ba(OH)₂ dissolved therein may be used.

In an embodiment, the coloring speed, the coloring power and the color uniformity of the metal matrix containing magnesium were evaluated. As a result, when a solution in which NaOH had been dissolved was used as a hydroxide solution, it was confirmed that the coloring speed thereof was four times faster as compared to that of the case in which distilled water was used. Further, it was determined that the coloring power of the color developed on the surface was excellent, and a uniform color was realized. As can be seen from the results, when a solution in which a metal hydroxide such as NaOH or the like is dissolved is used as a hydroxide solution, the film is uniformly formed on the surface of the metal matrix in a short time, and thus a color may be realized by excellent coloring power (refer to Experimental Example 1).

Further, the preparation method according to the present invention may control the thickness of the film formed on the surface of the matrix according to immersion conditions. Here, since the amount of heat conduction of the matrix varies depending on the thickness of the matrix, when the thicknesses of the matrices are different, the thickness of the films formed on matrices may be different even though the matrices were immersed under the same conditions. Accordingly, it is preferable to control the thickness of the film by adjusting immersion conditions according to the thickness of the matrix containing magnesium.

As an example, when the thickness of the matrix containing magnesium is in the range of 0.4 to 0.7 T, the concentration of the hydroxide solution may range from 1 to 80 wt %, and more specifically, from 1 to 70 wt %; 5 to 50 wt %; 10 to 20 wt %; 1 to 40 wt %; 30 to 60 wt %; 15 to 45 wt %; or 5 to 20 wt %. Moreover, the temperature of the hydroxide solution may range from 90 to 200° C., more specifically, from 100 to 150° C., and even more specifically, from 95 to 110° C. Further, the immersion time may be in the range of 1 to 500 minutes, and specifically, in the range of 10 to 90 minutes. In the present invention, various colors may be economically realized on the surface of the substrate within the above-described ranges.

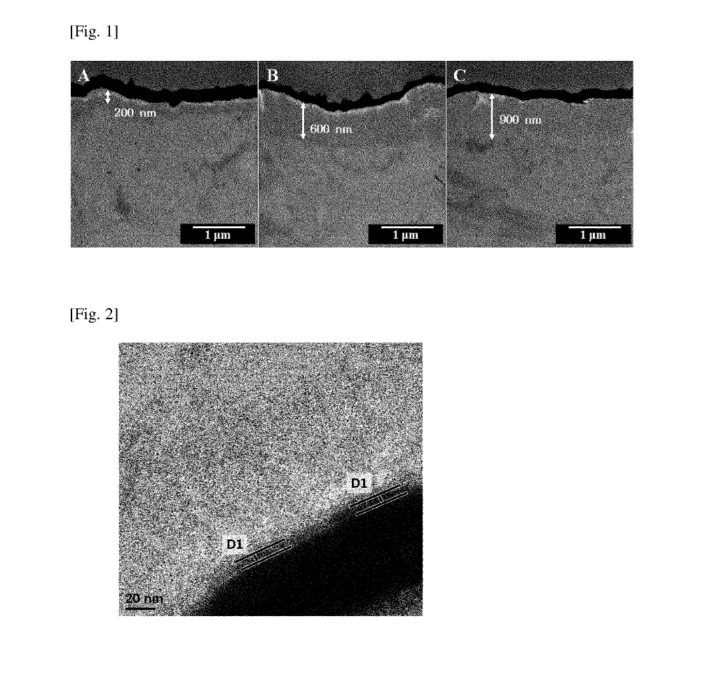

Referring to FIG. 1, it can be determined that the average thickness of the film formed on the surface of the substrate increases as the immersion time of the metal matrix passes, and a developed color is changed accordingly. This indicates that the color realized on the surface is changed according to the thickness of the film. Therefore, it can be seen that the color realized on the surface of the substrate may be adjusted by controlling the concentration and temperature of the hydroxide solution for immersing the matrix and the immersion time (refer to Experimental Example 2).

Further, in the method of surface-treating the substrate according to the present invention,

the step of forming the film on the metal matrix may include: a first immersion step of immersing in a hydroxide solution with a concentration of N1; and an nth immersion step of immersing in a hydroxide solution with a concentration of Nn, and the first immersion step and the nth immersion step may be carried out using a method in which the concentration of the hydroxide solution satisfies the following Expressions 1 and 2 independently of each other, and n is an integer of 2 or more and 6 or less:

8≦N₁≦25 [Expression 1]

|Nₙ₋₁−Nₙ|>3 [Expression 2]

where N₁ and Nₙ represent a concentration of a hydroxide solution in each step, and have units of wt %.

As described above, the step of forming the film on the metal matrix is a step of realizing a color on the surface of the metal matrix, and the developed color may be controlled by adjusting the thickness of the formed film. Here, since the thickness of the film may be controlled according to the concentration of the hydroxide solution, when the concentration of the hydroxide solution for immersing the matrix is divided into N₁ to Nₙ, and specifically, N₁ to N₆; N₁ to N₅; N₁ to N₄; N₁ to N₃; or N₁ to N₂; and the matrix is sequentially immersed therein, minute differences in the color realized on the surface may be controlled.

Further, the method of surface-treating the substrate according to the present invention may further include one or more steps of:

pretreating a surface before the step of forming the film on the metal matrix; and

rinsing after the step of forming the film on the metal matrix.

Here, the step of pretreating the surface is a step of eliminating contaminants remaining on the surface by treating the surface using an alkaline cleaning solution or grinding the surface before immersing the metal matrix in the hydroxide solution. Here, the alkaline cleaning solution is not particularly limited as long as the solution is generally used to clean a surface of metals, metal oxides or metal hydroxides in the related field. Further, the grinding may be performed by buffing, polishing, blasting, electrolytic polishing or the like, but is not limited thereto. In the present step, not only contaminants or scale which is present on the surface of the matrix containing magnesium may be removed, but also the speed of forming the film may be controlled by surface energy of the surface and/or surface conditions, specifically, microstructural changes of the surface. That is, the thickness of the film formed on the polished matrix may be different from that of the film formed on the unpolished matrix even though the film is formed on the polished matrix under the same conditions as the film of the unpolished matrix, and each color developed on the surface may be different accordingly.

Moreover, the step of rinsing is a step of eliminating any hydroxide solution remaining on the surface by rinsing the surface after the step of immersing the metal matrix in the hydroxide solution. In this step, additional formation of the film due to any remaining hydroxide solution may be prevented by removing the hydroxide solution remaining on the surface of the matrix.

Next, the step of forming the wavelength conversion layer is a step of forming a wavelength conversion layer which is capable of preventing a color developed by a film from being changed due to a top coat.

When only the film and top coat are formed on the metal matrix, color-developing light for coloring may be refracted and scattered again in the top coat, and thereby a color developed on the surface may be changed. Here, the degree of discoloring may vary according to the average thickness of the top coat. For example, when the average thickness of the top coat is in the range of 5 to 20 μm, a color may be changed to brown, and when the average thickness of the top coat is 30 μm or more, a color may be changed to black. However, when the wavelength conversion layer is interposed between the film and top coat according to the present invention, the wavelength conversion layer may prevent a change in a color developed by the film by minimizing refraction and scattering of the color-developing light due to the top coat and inducing light reflection.

Here, the wavelength conversion layer may be formed by a method which is generally used to form a wavelength conversion layer in the related field. Specifically, it may be formed by a method such as vacuum deposition, sputtering, ion plating, ion beam deposition or the like.

Furthermore, a material of the wavelength conversion layer is not particularly limited as long as the material may maintain a color developed by the film by minimizing additional refraction and scattering of the color-developing light due to the top coat and reflecting the light. As an example, the wavelength conversion layer may include one or more metals selected from the group consisting of metals including aluminum (Al), chromium (Cr), titanium (Ti), gold (Au), molybdenum (Mo), silver (Ag), manganese (Mn), zirconium (Zr), palladium (Pd), platinum (Pt), cobalt (Co), cadmium (Cd) or copper (Cu) and ions thereof.

Next, the step of forming the top coat on the wavelength conversion layer is a step of introducing a top coat on a wavelength conversion layer using a matte or glossy/matte clear coating agent so as to improve scratch resistance and durability of a substrate.

Here, the top coat may be formed by a method which is generally used to form a top coat on a wavelength conversion layer in the related field.

### MODES OF THE INVENTION

Hereinafter, the present invention will be described in further detail with reference to examples and experimental examples.

However, the following examples and experimental examples are for illustrative purposes only and not intended to limit the scope of the present invention.

### EXAMPLE 1

A magnesium-containing sample with a size of 1 cm×1 cm×0.4 T as a metal matrix, was degreased by immersing in an alkaline cleaning solution, and the degreased sample was immersed in a 10 wt % NaOH solution at 100° C. for 50 minutes. Thereafter, the sample was rinsed using distilled water and dried in a drying oven, and a chromium (Cr) layer having a thickness in the range of 10 to 20 nm was formed using a sputtering method. The chromium (Cr) layer was coated with a matte clear coating material in a liquid phase, and dried in an oven at 120 to 150° C. to prepare a surface-treated magenta sample. Here, an average thickness of a matte clear coating layer was 25 μm.

### EXAMPLE 2

A surface-treated green sample was prepared in the same manner as in Example 1 except that the sample was immersed for 85 minutes instead of 50 minutes.

### EXAMPLE 3

A surface-treated silver sample was prepared in the same manner as in Example 1 except that the sample was immersed for 10 minutes instead of 50 minutes. Transmission electron microscope imaging was performed on the prepared sample, and the result is shown in FIG. 2. As shown in FIG. 2, it was determined that an average thickness D1 of a chromium layer formed on the sample was about 10 nm

### EXAMPLE 4

A surface-treated silver sample was prepared in the same manner as in Example 1 except that the sample was immersed for 10 minutes instead of 50 minutes and an aluminum (Al) layer was formed instead of a chromium (Cr) layer. Transmission electron microscope imaging was performed on the prepared sample, and the result is shown in FIG. 3. As shown in FIG. 3, it was determined that an average thickness D2 of an aluminum layer formed on the sample was about 13 nm

### COMPARATIVE EXAMPLE 1

A magnesium-containing sample with a size of 1 cm×1 cm×0.4 T as a metal matrix, was degreased by immersing in an alkaline cleaning solution, and the degreased sample was immersed in a 10 wt % NaOH solution at 100° C. for 85 minutes. Thereafter, the sample was rinsed using distilled water, dried in a drying oven, and coated with a matte clear coating material in a liquid phase, and dried in an oven at 120 to 150° C. to prepare a surface-treated sample. Here, an average thickness of a matte clear coating layer was 5 μm.

### COMPARATIVE EXAMPLE 2

A surface-treated sample was prepared in the same manner as in Comparative Example 1 except that coating was performed such that an average thickness of a matte clear coating layer was 30 μm instead of 5 μm.

### EXPERIMENTAL EXAMPLE 1

### Evaluation of Coloring Efficiency of Substrate according to Type of Hydroxide Solution

In order to evaluate a coloring speed and coloring power of a color-treated substrate according to a type of a hydroxide solution, the following experiment was performed.

Magnesium-containing samples with a size of 1 cm×1 cm×0.4 T as a metal matrix were degreased by immersing in an alkaline cleaning solution, and the degreased samples each were immersed in a 10 wt % NaOH solution at 100° C. for 40 minutes, 1 hour and 2 hours, respectively. Thereafter, the sample was rinsed using distilled water and dried in a drying oven, and colors developed on the surface were evaluated with the naked eye.

As a result, it was determined that the sample prepared by immersing in a 10 wt % NaOH solution has a faster coloring speed in comparison with that of a sample prepared by immersing in distilled water as a hydroxide solution. More specifically, the sample prepared by immersing in a 10 wt % NaOH solution was colored to have a silver color after 10 minutes of immersion, and changed to a yellow color, and then colored to have an orange color within 40 minutes. However, in the case of the sample of which the immersion time was 40 minutes, it was determined that a color change amount of the surface was slight and a color difference was not so large as compared to a non-color-treated substrate, and the sample of which the immersion time was 1 hour was gradually colored to have a yellow color. Further, the sample of which the immersion time was 2 hours was colored to have a yellow color, but the coloring power of the developed color was significantly lower than that of the sample prepared by immersing in a 10 wt % NaOH solution.

From these results, it can be seen that the surface treatment of the substrate performed using a hydroxide solution including NaOH, KOH, Mg(OH)₂, Ca(OH)₂, Ba(OH)₂ or the like, has high efficiency and the color developed therefrom is also uniform.

### EXPERIMENTAL EXAMPLE 2

### Evaluation of Coloring of Substrate according to Time of Immersion in Hydroxide Solution

In order to evaluate the degree of coloring of a metal matrix according to the time of immersion in a hydroxide solution, the following experiment was performed.

A magnesium-containing sample with a size of 1 cm×1 cm×0.4 T as a metal matrix was degreased by immersing in an alkaline cleaning solution, and the degreased sample was immersed in a 10 wt % NaOH solution at 100° C. for 240 minutes. Here, a developed color was observed with the naked eye at intervals of 5 to 10 minutes immediately after the sample was immersed in the NaOH solution. Further, X-ray diffraction analysis and transmission electron microscope (TEM) imaging of the film was performed on the sample after 10 minutes, 170 minutes and 240 minutes of immersion in order to determine the component and thickness of the film formed on the surface of the sample. The result is shown in FIG. 1.

The surface-treated substrate according to the present invention was determined to have a developed color varying according to the time of immersion in the hydroxide solution. More specifically, when the non-color-treated sample having a silver color was immersed in the hydroxide solution, it was determined that yellow, orange, red, purple, blue and green colors were sequentially developed after 30 minutes of immersion, and this color change becomes repeated at a predetermined interval over time.

Further, as a result of performing X-ray diffraction analysis on the films, all the films of three samples were determined to have 2θ diffraction peak values of 18.5±1.0°, 38.0±1.0°, 50.5±1.0°, 58.5±1.0°, 62.0±1.0° and 68.5±1.0°, and were confirmed to include magnesium hydroxide (Mg(OH)₂) having a brucite crystalline structure.

Moreover, as can be seen from FIG. 1, the average thickness of the film is increased to about 200 nm, 600 nm and 900 nm as each immersion time has passed.

From these results, it can be seen that the surface-treated substrate according to the present invention realizes coloring by including the film containing magnesium hydroxide (Mg(OH)₂). Further, it can be seen that the thickness of the film formed on the surface may be controlled according to the immersion time of the metal matrix containing magnesium, and the color developed therefrom may be controlled.

### EXPERIMENTAL EXAMPLE 3

### Evaluation of Color and Color Uniformity of Surface-Treated Substrate

In order to evaluate a color and color uniformity of the surface-treated substrate according to the present invention, the following experiment was performed.

Colors of samples surface-treated in Examples 1 and 2, Comparative Examples 1 and 2 were evaluated with the naked eye. Further, any three points A to C on the sample prepared according to Example 2 were selected, and color coordinates (L*, a*, b*) in a CIE color space of the selected points were measured. Further, color coordinate deviations were calculated from the measured color coordinates, and were shown in the following Table 1. Here, the color coordinate deviations (ΔE*) were derived using the following Expression 3.

ΔE*=\sqrt{(ΔL*)²+(Δα*)²+(Δb*)²} [Expression 3]

TABLE 1

| 3 | | | | | | | |
|---|---|---|---|---|---|---|---|
| points | L* | a* | b* | ΔL* | Δa* | Δb* | ΔE* |
| A | 61.15 | −12.20 | 5.24 | — | — | — | — |
| B | 61.01 | −12.18 | 5.64 | 0.14 | 0.02 | 0.40 | 0.424264 |
| C | 60.80 | −12.52 | 5.58 | 0.34 | 0.32 | 0.34 | 0.577581 |

As a result, it can be seen that a color developed by the film is maintained after forming the top coat by including the wavelength conversion layer in the case of the surface-treated substrate according to the present invention. More specifically, it was determined that colors realized on the surface by the film were respectively magenta and green colors before forming the wavelength conversion layer in Examples 1 and 2, and colors of the surfaces were not changed although the wavelength conversion layers and top coats were sequentially formed afterward. In contrast, in the case of Comparative Examples 1 and 2, it was determined that colors realized on the surface by the film were respectively magenta and green colors before forming the top coat, but the colors realized on the surface were changed when the top coat was formed on the film. Here, the colors were respectively changed to brown and black colors in accordance with the thickness of the top coat.

This indicates that, light incident to the surface of the metal matrix is refracted and scattered by the film and converted to color-developing light, but the color-developing light is refracted and scattered again while passing though the top coat and leads to the occurrence of discoloration in the case of the samples of comparative examples, on the other hand, a wavelength conversion layer minimizes additional refraction and scattering of color-developing light and realizes light reflection to prevent discoloration in the case of the samples of examples in which the wavelength conversion layer is formed between the film and top coat.

Further, as shown in Table 1, it can be seen that the surface-treated substrate according to the present invention has a uniformly developed color. More specifically, the average color coordinate deviation of any three points existing on the sample were determined as 0.14≦ΔL*<0.34, 0.02≦Δa*<0.34 and 0.34≦Δb*<0.40 and 0.424≦ΔE*<0.578 in the case of the sample of Example 2 which includes a wavelength conversion layer. This indicates that a color of color-treated magnesium according to the present invention was uniformly developed.

From these results, it can be seen that, when a top coat is formed on a film in order to improve scratch resistance and durability of a substrate, a wavelength conversion layer which is capable of preventing discoloration is required to be interposed between the film and top coat, and a surface-treated substrate including the wavelength conversion layer has a uniformly developed color.

Accordingly, the surface-treated substrate according to the present invention may uniformly realize a color by including a film having a uniform thickness on a metal matrix. Further, scratch resistance and durability of the substrate may be improved without a change in a color developed on the film by sequentially including a wavelength conversion layer and a top coat on the film.

### INDUSTRIAL APPLICABILITY

The surface-treated substrate according to the present invention not only can improve corrosion resistance, but also can uniformly develop a color on a surface by including a film having a uniform thickness on a metal matrix. Further, scratch resistance and durability of the substrate can be improved without a change in a color developed on the film by sequentially including a wavelength conversion layer and a top coat on the film, and thus the surface-treated substrate according to the present invention can be usefully used in the fields of building exterior materials, automobile interiors, and particularly electrical and electronic component materials, such as mobile phone case components, in which a magnesium material is used.

1. A surface-treated substrate, comprising:
a metal matrix;
a film formed on the matrix and containing a compound represented by the following Chemical Formula 1;
a wavelength conversion layer formed on the film; and
a top coat formed on the wavelength conversion layer:
M(OH)ₘ [Chemical Formula 1]
where M includes one or more selected from the group consisting of Na, K, Mg, Ca and Ba, and m is 1 or 2.

2. The surface-treated substrate according to claim 1, wherein the wavelength conversion layer includes one or more selected from the group consisting of metals including aluminum (Al), chromium (Cr), titanium (Ti), gold (Au), molybdenum (Mo), silver (Ag), manganese (Mn), zirconium (Zr), palladium (Pd), platinum (Pt), cobalt (Co), cadmium (Cd) or copper (Cu) and ions thereof.

3. The surface-treated substrate according to claim 1, wherein an average thickness of the wavelength conversion layer is in a range of 5 to 200 nm

4. The surface-treated substrate according to claim 1, wherein, at any three points included in an arbitrary region with a width of 1 cm and a length of 1 cm which is present on the top coat, an average color coordinate deviation (ΔL*, Δa*, Δb*) of each point satisfies one or more conditions of ΔL*<0.5, Δa*<0.7 and Δb*<0.6.

5. The surface-treated substrate according to claim 1, wherein an average thickness of the film is in a range of 50 nm to 2 μm.

6. The surface-treated substrate according to claim 1, wherein the metal matrix further includes stainless steel or titanium (Ti).

7. A method of surface-treating a substrate, comprising:
a step of forming a film on a metal matrix;
a step of forming a wavelength conversion layer on the film; and
a step of forming a top coat on the wavelength conversion layer.

8. The method according to claim 7, wherein the film is formed by immersing the metal matrix in a hydroxide solution in the step of forming the film on the metal matrix.

9. The method according to claim 8, wherein the hydroxide solution includes one or more selected from the group consisting of NaOH, KOH, Mg(OH)₂, Ca(OH)₂ and Ba(OH)₂.

10. The method according to claim 9, wherein a concentration of the hydroxide solution is in a range of 1 to 80 wt %.

11. The method according to claim 8, wherein
the step of forming the film on the metal matrix includes:
a first immersion step of immersing in a hydroxide solution with a concentration of N₁; and
an n^{th} immersion step of immersing in a hydroxide solution with a concentration of Nₙ,
the concentration of the hydroxide solution in the first immersion step and the n^{th} immersion step satisfies the following Expressions 1 and 2 independently of each other, and n is an integer of 2 or more and 6 or less:
8≦N₁≦25 [Expression 1]

|Nₙ₋₁−Nₙ|>3 [Expression 2]
where N₁ and Nₙ represent a concentration of a hydroxide solution in each step, and have units of wt %.

12. The method according to claim 7, wherein the step of forming the wavelength conversion layer is performed by vacuum deposition, sputtering, ion plating or ion beam deposition.

13. The method according to claim 7, wherein the wavelength conversion layer includes one or more metals selected from the group consisting of metals including aluminum (Al), chromium (Cr), titanium (Ti), gold (Au), molybdenum (Mo), silver (Ag), manganese (Mn), zirconium (Zr), palladium (Pd), platinum (Pt), cobalt (Co), cadmium (Cd) or copper (Cu) and ions thereof in the step of forming the wavelength conversion layer.

14. The method according to claim 7, further comprising one or more steps of:
pretreating a surface before the step of forming the film on the metal matrix; and
rinsing after the step of forming the film on the metal matrix.
